(19) United States
(12) Patent Application Publication
(10) Pub. No.: US 2016/0207007 A1
(43) Pub. Date: Jul. 21, 2016

(54) CHITOSAN ULTRA-THIN FILM COMPOSITE NANOFILTRATION MEMBRANES

(71) Applicant: National University of Singapore, Singapore (SG)

(72) Inventors: Sui Zhang, Singapore (SG); Ming Hui Peh, Singapore (SG); Tai-Shung Chung, Singapore (SG)

(21) Appl. No.: 14/996,478

(22) Filed: Jan. 15, 2016

Related U.S. Application Data
(60) Provisional application No. 62/103,788, filed on Jan. 15, 2015.

(51) Int. Cl. B01D 71/08; B01D 69/12; B01D 69/02; B01D 61/02

(52) U.S. Cl. CPC B01D 71/08; B01D 61/027; B01D 69/125; B01D 69/02; B01D 2325/02; B01D 2325/04; B01D 2323/30; B01D 2323/40

(57) ABSTRACT

A composite nanofiltration membrane that includes a support layer having a thickness of 100 nm to 10 mm and a cross-linked chitosan thin layer having a thickness of 10 to 1000 nm, in which the support layer is formed of a polymer; the cross-linked chitosan thin layer, disposed only on the top surface of the support layer, contains links each formed from a cross-linking agent, which is trimesoyl chloride, iso-phthaloyl dichloride, sebacoyl chloride, or a combination thereof; and the membrane has a mean pore size less than 1 nm. Also disclosed are a method for preparing such a composite nanofiltration membrane and a composite nanofiltration membrane prepared according to the method.

### CROSS REFERENCE TO RELATED APPLICATIONS

This application claims the benefit of U.S. Provisional Application No. 62/103,788, filed on Jan. 15, 2015, the content of which is hereby incorporated by reference in its entirety.

### BACKGROUND

Filtration membranes have attracted great attention due to their various applications, including, among others, wastewater purification and separation. Industrial processes, such as electroplating and metal surface treatment, produce a significant amount of wastewater containing heavy metals, e.g., lead and nickel.

Use of filtration membranes is limited by two major obstacles: a low water permeability rate and a low salt rejection rate. Membranes with a low water permeability rate result in low efficiency and high cost. On the other hand, a low salt rejection rate, i.e., loss of selectivity toward heavy metals, leads to poor performance in removing hazardous heavy metals from wastewater.

There is a need to develop a new filtration membrane that is highly water-permeable and effective in removing heavy metals.

### SUMMARY

This invention relates to a composite nanofiltration membrane, which demonstrates, unexpectedly, both a high pure water permeability rate and a high salt rejection rate.

In one aspect, the present invention is a composite nanofiltration membrane. The membrane includes a support layer having a thickness of 100 nm to 10 mm and a cross-linked chitosan thin layer having a thickness of 10 to 1000 nm. The support layer is formed of a polymer. The cross-linked chitosan thin layer contains links each formed from a cross-linking agent Importantly, the cross-linked chitosan thin layer is disposed only on the top surface of the support layer. The composite nanofiltration membrane has a mean pore size less than 1 nm.

Typically, the composite nanofiltration membrane has a pure water permeability rate of 1 to 10 Lm⁻²h⁻¹bar⁻¹, a MgCl₂ rejection rate of 85 to 99.9%, a Pb(NO₃)₂ rejection rate of 85 to 99.9%, and a NiCl₂ rejection rate of 85 to 99.9%.

In another aspect, this invention is a method for preparing such a composite nanofiltration membrane. The method includes the following steps: (1) providing a support layer, (2) dissolving chitosan in a solvent to form a chitosan solution having a chitosan concentration greater than 0.5 wt % and less than 10 wt %, (3) coating only the top surface of the support layer with the chitosan solution to obtain a chitosan thin layer, (4) drying the chitosan thin layer thus obtained to remove the solvent, and (5) cross-linking the chitosan thin layer thus dried with a cross-linking agent via interfacial polymerization to form a composite nanofiltration membrane.

Also within the scope of this invention is a composite nanofiltration membrane prepared by the method described above. The nanofiltration membrane thus prepared contains a support layer having a thickness of 100 nm to 10 mm and a cross-linked chitosan thin layer having a thickness of 10 to 1000 nm, in which the cross-linked chitosan thin layer is disposed only on the top surface of the support layer. Features of the nanofiltration membrane thus prepared also include (i) the support layer is formed of a polymer, (ii) the cross-linked chitosan thin layer contains links each formed from a cross-linking agent, and (iii) the composite nanofiltration membrane has a mean pore size less than 1 nm.

The details of one or more embodiments of the invention are set forth in the description below. Other features, objects, and advantages of the invention will be apparent from the following detailed description of several embodiments, and also from the appending claims.

### DETAILED DESCRIPTION

Disclosed in detail herein is a composite nanofiltration membrane of this invention that includes a support layer having a thickness of 100 nm to 10 mm (e.g., 50 to 500 μm or 50 to 200 μm) coated with a cross-linked chitosan thin layer having a thickness of 10 to 1000 nm (e.g., 60 to 300 nm or 60 to 100 nm) The membrane can exhibit various morphologies, including a macrovoid structure and a sponge-like structure.

The material used to form the support layer can be ceramic or polymeric. Examples of a polymeric material include, but are not limited to, poly(ether sulfone), polysulfone, sulphonated polymers. An exemplary support layer is formed of poly(ether sulfone) (PES). It can be a flat sheet or a hollow fiber.

The cross-linked chitosan thin layer contains links each formed from a cross-linking agent. The cross-linking agent can be an organic compound containing a halo group (e.g., an acyl halide), a silyl group (e.g., an acylsilane), or a siloxane group (e.g., an acyl siloxane). Examples of the cross-linking agent include, but are not limited to, trimesoyl chloride (TMC), iso-phthaloyl dichloride, sebacoyl chloride, and a combination thereof.

It is critical that the cross-linked chitosan thin layer is disposed only on the top surface of the support layer. In other words, only one surface, i.e., the top surface, of the support layer is coated with the cross-linked chitosan thin layer.

The composite nanofiltration membrane typically has a mean pore size greater than 0.3 nm and less than 1 nm or greater than 0.3 nm and less than 0.7 nm.

Also disclosed in detail herein is a method of preparing such a composite nanofiltration membrane.

A support layer, formed from a polymer solution, is provided; chitosan is dissolved in a solvent to form a chitosan solution having a chitosan concentration greater than 0.5 wt % and less than 10 wt %; the chitosan solution is coated onto only the top surface of the support layer to obtain a chitosan thin layer, which is subsequently dried to remove the solvent; and the chitosan thin layer thus dried is cross-linked with a cross-linking agent via interfacial polymerization to form a composite nanofiltration membrane.

The polymer solution, from which the support layer is formed, is prepared by dissolving a polymer, e.g., PES, in a solvent. Examples of the solvent include, but are not limited to, dimethylformamide, dimethylacetamide, N-methyl-2-pyrrolidone, dimethylsulfoxide and 1, 3-dimethyl-2-imidazolidinone or a mixture thereof. The polymer solution can be prepared in the presence or absence of a pore-forming agent. Examples of the pore-forming agent include, but are not limited to, an alkylene glycol and inorganic salts. It can also be prepared in the presence or absence of a non-solvent. The term “non-solvent” herein refers to a substance incapable of dissolving a given component of a solution or mixture. Examples of the non-solvent include, but are not limited to, water and alcohols. The support layer can be formed from the polymer solution by a non-solvent induced wet phase inversion method.

The solvent, in which chitosan is dissolved to form a chitosan solution, can be water, acetic acid, or an aqueous solution mixed with a miscible liquid (e.g., an alcohol). The chitosan solution typically has a chitosan concentration greater than 0.5 wt % and less than 3 wt % or greater than 0.5 wt % and less than 2 wt %.

The support layer is coated with the chitosan solution at its top surface as follows. The coating step is performed by pouring the chitosan solution thus formed onto the top surface of the support layer and soaking for an extended period of time. Duration of the coating step can be from 2 seconds to 15 minutes (e.g., 30 seconds to 5 minutes or 1 to 3 minutes). The excess amount of the chitosan solution is removed from the support layer to obtain a chitosan thin layer, which is subsequently dried for an extended period of time. Duration of the drying step can be from 12 to 24 hours (e.g., 12 to 18 hours or 14 to 18 hours). Typically, the drying step is performed at a temperature of 15 to 65° C. (e.g., 15 to 50° C. or 20 to 35° C.).

The drying step can be performed in a fume hood. Drying in a fume hood greatly reduces the water content in the chitosan-coated support layer from greater than 70% to less than 3%. The chitosan thin layer becomes highly dense after being dried for 12 hours or more. During the drying process, polymer chains in the initial chitosan solution gradually rearrange and fold, and eventually form granules on the surface of the support layer. Typically, extended drying for 24 hours results in a membrane layer with a water content below 1.0 wt % and a very rough surface.

A cross-linking agent is dissolved in a solvent to prepare a cross-linker solution. It is important that the solvent for preparing the cross-linker solution is immiscible with water. It can be a pure organic solvent (e.g., hexane) or a solvent mixture (e.g., hexane and ether). The cross-linking agent used in the method can be an organic compound containing a halo group (e.g., an acyl halide), a silyl group (e.g., an acylsilane), or a siloxane group (e.g., an acyl siloxane). An exemplary cross-linking agent is TMC, iso-phthaloyl dichloride, sebacoyl chloride, or a combination thereof. The cross-linker solution thus prepared can have a concentration from 0.1 (wt/vol) % to 10 (wt/vol) % or from 0.1 (wt/vol) % to 5 (wt/vol) %.

The cross-linker solution is poured onto the dried chitosan thin layer, allowing the cross-linking agent to react with chitosan for an extended period of time, during which cross-linking following interfacial polymerization takes place to form a cross-linked chitosan thin layer on the top of the support layer.

Scheme 1 below shows a process of interfacial polymerization, in which chitosan is cross-linked by linkers formed from TMC.

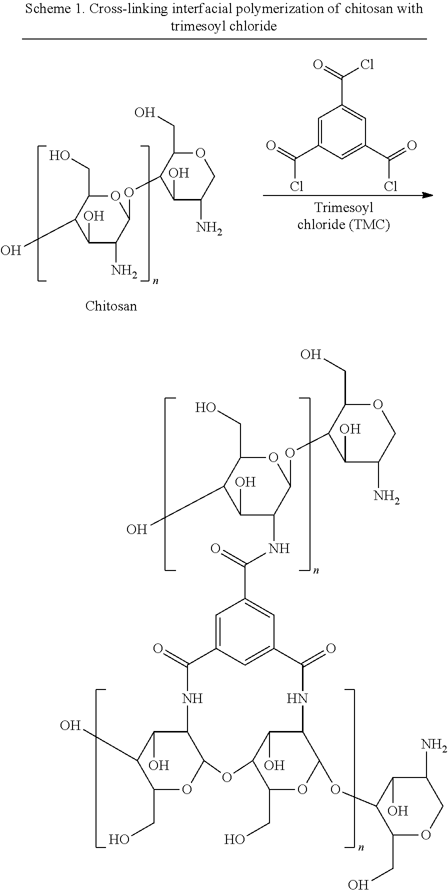

Duration of the cross-linking following interfacial polymerization can be from 2 seconds to 10 minutes (e.g., 30 seconds to 5 minutes or 30 seconds to 3 minutes). The excess amount of the cross-linker solution is drained off to obtain a composite nanofiltration membrane. The membrane thus obtained can be washed and stored in de-ionized water.

Also within the scope of this invention is a composite nanofiltration membrane prepared by the method described above. The nanofiltration membrane thus prepared contains a support layer having a thickness of 100 nm to 10 mm and a cross-linked chitosan thin layer having a thickness of 10 to 1000 nm, in which the cross-linked chitosan thin layer is disposed only on the top surface of the support layer. Features of the nanofiltration membrane thus prepared include that the cross-linked chitosan thin layer contains links each formed from a cross-linking agent and the composite nanofiltration membrane has a mean pore size less than 1 nm.

The nanofiltration membrane of this invention demonstrates a high pure water permeability rate and high salt rejection rates. An exemplary composite nanofiltration membrane fabricated according to the above-described method showed a pure water permeability rate of 3.45±0.25 Lm⁻²h⁻¹bar⁻¹, a MgCl₂ rejection rate of 96.3±0.6%, a Pb(NO₃)₂ rejection rate of 93.0±2.7%, and a NiCl₂ rejection rate of 96.3±2.5%. See EXAMPLE 2 below.

The composite nanofiltration membrane can be used in various applications including, among others, wastewater treatment and protein separation. For example, it can be used in a filtration process for wastewater purification with the water source being a mixture of seawater and wastewater.

Without further elaboration, it is believed that one skilled in the art can, based on the description herein, utilize the present invention to its fullest extent. The specific examples below are to be construed as merely illustrative, and not limitative of the remainder of the disclosure in any way whatsoever. All publications cited herein are incorporated by reference in their entirety.

### Example 1

### Preparation of Composite Nanofiltration Membranes

Described below are methods of preparing three different composite nanofiltration membranes with water-insoluble TMC and water-soluble formaldehyde and glutaraldehyde, separately. The membrane prepared with TMC is a membrane of this invention. The other two membranes prepared with formaldehyde and glutaraldehyde are fabricated for performance comparison.

Radel PBS polymer (Solvay Advanced Polymer, LLC), N-methyl-2-pyrrolidone (NMP; >99.5% Merck), and polyethylene glycol (PBG; MW 400, Sigma-Aldrich) were purchased to prepare the membrane substrate layer. Chitosan (medium molecular weight, 75-85% deacetylated, Sigma-Aldrich) and acetic acid (HPLC, TBDIA) were used to prepare the chitosan thin layer. Formaldehyde (37 wt % in water, Comaic Laboratory), glutaraldehyde (50 wt % in water, Sigma-Aldrich), and trimesoyl chloride (TMC; 98%, Sigma-Aldrich) were used as cross-linking agents. Hexane (99.9%, Fisher Scientific) was used as a solvent in preparing a cross-linker solution.

Membrane Preparation with TMC

A poly(ether sulfone) (PES) substrate layer was prepared according to the procedure reported in Zhang et al., Environ. Sci. Technol. 2013, 47, 10085-10092. More specifically, a polymer solution formed of 20.4 wt % PES, 37.7 wt % NMP, 37.7 wt % PEG, and 4.2 wt % water was casted over a clean glass plate using a casting knife with a height of 150 μm to form an assembly. The assembly thus formed was immediately immersed in a water bath for phase inversion to take place at room temperature to obtain a phase inversed layer. The phase inversed layer was then taken out, washed, and stored in de-ionized (DI) water for further use.

A chitosan solution was prepared by dissolving chitosan powder in 500 ml of 2.0 wt % acetic acid to form a 2.0 wt % stock solution. The chitosan solution was further diluted to produce concentrations ranging from 0.25-1.5 wt %.

The PES substrate layer was first placed on a rectangular frame so that only the top surface was exposed to the chitosan solution. The chitosan solution thus prepared was poured onto the PES substrate layer and allowed soaking for 2 minutes. The excess solution was dripped off and the chitosan-coated layer was left in a fume hood to dry for various durations (12-24 hours). A solution of 0.2 wt % TMC in hexane was poured onto the chitosan-coated layer and allowed to react for 1 minute, which resulted in cross-linked chitosan thin layer over the PES substrate layer. The excess TMC solution was then drained off to provide a composite nanofiltration membrane, which was washed and stored in DI water before use.

Comparison of morphology of the support layer and that of the cross-linked chitosan thin layer indicates that the layer surface became dense after coating with the chitosan thin layer. In addition, polymeric granules were formed on the surface after coating and their sizes increased with increasing duration of the drying step described above.

Membrane Preparation with Formaldehyde and Glutaraldehyde

By following the procedure described above, the other two composite nanofiltration membranes were also prepared using formaldehyde or glutaraldehyde as a cross-linking agent. The former membrane was prepared using 0.5 wt % chitosan and 2.0 wt % formaldehyde in water, with drying for 32 minutes at 23° C.; and the latter one was prepared using 1.0 wt % chitosan and 1.0 wt % glutaraldehyde in water, with drying for 18 hours at 23° C.

### Comparison Between the Three Nanofiltration Membranes

Morphologies of the three chitosan-PES membranes cross-linked by different cross-linking agents were obtained. It was observed that the membranes prepared with glutaraldehyde and formaldehyde showed integrated top layer at the cross-section, yet the membrane prepared with TMC showed a distinct boundary between chitosan and the PES support layer due to its unique interfacial crosslinking as a water-insoluble cross-linker agent.

Regarding the membrane prepared with TMC, the chitosan thin layer thickness was found to be dependent on the chitosan concentration. More specifically, it was observed that the membranes had a chitosan thin layer thickness of 51±8 nm, 98±6 nm, and 335±15 nm with the chitosan concentration at 0.5 wt %, 1.0 wt %, and 1.5 wt %, respectively.

### Example 2

### Evaluation of Composite Nanofiltration Membranes

A study was conducted to evaluate the pure water permeability and salt rejection rates of the three composite nanofiltration membranes prepared in Example 1 as follows.

Pure water permeability measurements were carried out using high purity Milli-Q water. Magnesium chloride hexahydrate (MgCl₂.6H₂O; Merck), lead nitrate (Pb(NO₃)₂; 99%, Acros), and nickel chloride hexahy-drate (NiCl₂.6H₂O; 98+%, Acros) were employed to evaluate the salt rejections of the membranes.

The pure water permeability (PWP, Lm⁻²h⁻¹bar⁻¹, abbreviated as LMH bar⁻¹) and salts rejection (R, %) of the prepared membranes were tested at 10.0 bar by a dead-end stainless steel permeation cell under the nanofiltration mode. The tests were conducted at room temperature with an effective area of 3.14 or 7.07 cm².

The PWP values were calculated based on equation (1):

$$PWP = \frac{Δ V}{{S}_{m} t Δ P} \qquad ( 1 )$$

where ΔV (L) is the volume of permeate collected in a time span, t (h), Sₘ (m²) is the effective area of membrane, and ΔP (bar) is the applied trans-membrane pressure.

The salt rejection values were determined using 1000 ppm of MgCl₂, NaCl, Pb(NO₃)₂, and NiCl₂.6H₂O respectively as the feed under rapid stirring condition (500 rpm). Conductivity measurements (Schott Instruments Lab 960) of the feed and permeate were performed to calculate the solute rejection based on equation (2):

$$R = ( 1 - \frac{{C}_{P}}{{C}_{f}} ) * 100 \% \qquad ( 2 )$$

where C_{f} and Cₚ are, respectively, the solute concentrations of the feed and permeate, which are linearly correlated with conductivity at low concentration.

Membrane stability over 96 hours was tested in a similar way by continuously recording the PWP and MgCl₂ rejection values during the testing period.

It was observed that, under the condition of a drying time of 16 hours and a chitosan concentration of 1.0 wt %, the membrane crosslinked by TMC unexpectedly exhibited a high PWP rate of 3.45±0.25 Lm⁻²h⁻¹bar⁻¹ and a high MgCl₂ rejection rate of 96.3±0.6%.

In addition, the performance of the membrane was found to be highly dependent on the drying time and the chitosan concentration. More specifically, at a fixed chitosan concentration of 1.0 wt %, the membrane showed a PWP rate of about 2.6 Lm⁻²h⁻¹bar⁻¹ and a MgCl₂ rejection rate of about 70% with a drying time of 12 h, and a PWP rate of about 1.2 Lm⁻²h⁻¹bar⁻¹ and a MgCl₂ rejection rate of about 95% with a drying time of 24 h; on the other hand, with a fixed drying time of 16 h, the membrane showed a PWP rate of about 1.6 Lm⁻²h⁻¹bar⁻¹ and a MgCl₂ rejection rate of about 65% at a chitosan concentration of 0.5 wt %, and a PWP rate of about 1.8 Lm⁻²h⁻¹bar⁻¹ and a MgCl₂ rejection rate of about 94% at a chitosan concentration of 1.5 wt %.

Results shown in Table 1 below reveal that the membrane prepared with TMC demonstrated the best overall performance under the condition of a drying time of 16 h and a chitosan concentration of 1.0 wt %, compared to the other two membrane prepared with water-soluble glutaraldehyde and formaldehyde.

TABLE 1
The solvent (for cross-linker), PWP rate, and MgCl₂ rejection rate of
the cross-linked chitosan-PES membranes using different cross-linking
agents (drying time: 16 h; chitosan concentration 1.0 wt %). Test
hydraulic pressure: 10.0 bar. MgCl₂ concentration: 1000 ppm.

| | Glutaraldehyde | Formaldehyde | Trimesoyl chloride |
|---|---|---|---|
| Cross-linker | (GA) | (FA) | (TMC) |
| Solvent | Water | Water | Hexane |
| PWP, LMH bar⁻¹ | 0.07 ± 0.01 | 0.48 ± 0.12 | 3.45 ± 0.25 |
| MgCl₂ rejection, | 95.3 ± 0.4 | 95.2 ± 0.2 | 96.3 ± 0.6 |
| % | | | |

Heavy metal rejection rates of the nanofiltration membrane cross-linked by TMC are shown in Table 2 below. Unexpectedly, the membrane showed high rejection rates toward MgCl₂, Pb(NO₃)₂, and NiCl₂.

TABLE 2
The heavy metal rejection rates of the chitosan-PES membrane
cross-linked by TMC (drying time: 16 h; chitosan concentration:
1.0 wt %). Test hydraulic pressure: 10.0 bar. Salt
concentration: 1000 ppm.

| | Salt | | |
|---|---|---|---|
| | MgCl₂ | Pb(NO₃)₂ | NiCl₂ |
| Rejection, % | 96.3 ± 0.6 | 93.0 ± 2.7 | 96.3 ± 2.5 |

These results indicate that the composite nanofiltration membrane of this invention unexpectedly demonstrated a high PWP rate and high salt rejection rates.

The membrane's long-term stability was evaluated over 96 hours. It was observed that the composite nanofiltration membrane of this invention was unexpectedly quite stable.

### Example 3

### Characterization of Pore Size Distribution and Zeta Potential

A study was performed to evaluate the pore size distribution and zeta potential of the composite nanofiltration membrane as follows.

Ethylene glycol (Fisher Scientific), triethylene glycol (99%, Alfa Aesar), sucrose (>99.5%, Sigma-Aldrich), and raffinose pentahydrate (>98.0%, Sigma-Aldrich) were used for the measurement of pore size, pore size distribution and molecular weight cut-off (MWCO) of the membranes. Hydrochloric acid (HCl; 37%, Sigma-Aldrich) and sodium hydroxide (NaOH; >97%, Sigma-Aldrich) were prepared in aqueous solutions for zeta(ζ)-potential measurements.

All of the organic solutes were dissolved in DI water to form 200 ppm of solutions as the feed solutions for the tests. All tests were carried out at 10 bar and 23° C. During each test, the feed solution was stabilized for at least 1 hour before permeate collection. The organic permeate and feed concentrations were analysed by a total organic carbon analyzer (TOC ASI-5000A, Shimazu, Japan).

The solute rejection is related to the stokes radius, rₛ. A linear relationship between R and rₛ plotted on a log-normal probability graph was observed according to Equation (3):

F(R)=A+B ln rₛ (3)

where A and B are constants. The pore size distribution was then calculated with the assumption that no steric and hydrodynamic interactions between the neutral solutes and the membrane materials exists. The MWCO of the membrane is defined as the molecular weight of the solute which the membrane can reject 90% of it. The mean effective pore size, μₚ is assumed to the same as the geometric mean radius of the solute, μₛ when R=50%. The geometric standard deviation of the membrane, σₚ is assumed to be the geometric standard deviation, σ_{g}. The σ_{g} is the ratio of stokes radius when R=84.13% to that when R=50%. The probability density function of the membrane pore radius can be calculated using Equation (4):

$$\frac{d {R}_{T} ( {r}_{p} )}{d {r}_{p }} = \frac{1}{{r}_{p} ln {σ}_{p} \sqrt{2 π}} exp [ - \frac{{( ln {r}_{p} - ln {μ}_{p} )}^{2}}{2 {( ln {σ}_{p} )}^{2}} ] \qquad ( 4 )$$

where rₚ is the pore radius of the membrane.

The surface charge of the chitosan/PES nanofiltration membrane cross-linked by TMC was analysed by SurPASS electrokinetic analyzer (Anton Paar GmbH, Austria) with streaming electric potential measurements. First, a 0.01 M NaCl solution was used to test the zeta-potential of the membrane at neutral conditions. Then the zeta-potential of the membrane was tested with a 0.01 M NaCl solution under pH ranging from pH 3 to 10. The pH values were adjusted by the auto-titrations with 0.1 M HCl and 0.1 M NaOH. The zeta-potential as a function of pH values and thus the isoelectric point (pI) of the membrane were then determined.

It was observed that the nanofiltration membrane (chitosan concentration of 1.0 wt % and drying time of 16 h) had a mean pore size of 0.347 nm, an isoelectric point at pH=5, and a MWCO of 486 Da.

### Other Embodiments

All of the features disclosed in this specification may be combined in any combination. Each feature disclosed in this specification may be replaced by an alternative feature serving the same, equivalent, or similar purpose. Thus, unless expressly stated otherwise, each feature disclosed is only an example of a generic series of equivalent or similar features.

Indeed, to achieve the purpose of purification and separation, one skilled in the art can design a membrane that contains any combination of zwitterionic repeat units and hydrophobic repeat units. Further, the ratios and molecular weights of these repeat units can be so engineered to achieve separation of molecules of different molecular weights.

From the above description, a skilled artisan can easily ascertain the essential characteristics of the present invention, and without departing from the spirit and scope thereof, can make various changes and modifications of the invention to adapt it to various usages and conditions. Thus, other embodiments are also within the claims.

What is claimed is:

1. A composite nanofiltration membrane comprising:
a support layer having a thickness of 100 nm to 10 mm, and
a cross-linked chitosan thin layer having a thickness of 10 to 1000 nm and disposed only on a top surface of the support layer,
wherein
the support layer is formed of a polymer;
the cross-linked chitosan thin layer contains links each formed from a cross-linking agent; and
the composite nanofiltration membrane has a mean pore size less than 1 nm.

2. The composite nanofiltration membrane of claim 1, wherein the chitosan thin layer has a thickness of 60 to 300 nm.

3. The composite nanofiltration membrane of claim 2, wherein the support layer has a thickness of 50 to 500 μm.

4. The composite nanofiltration membrane of claim 2, wherein the polymer is poly(ether sulfone) and the cross-linking agent is selected from the group consisting of trimesoyl chloride, iso-phthaloyl dichloride, sebacoyl chloride, and a combination thereof.

5. The composite nanofiltration membrane of claim 2, wherein the composite nanofiltration membrane has a mean pore size greater than 0.3 nm.

6. The composite nanofiltration membrane of claim 5, wherein the composite nanofiltration membrane has a mean pore size less than 0.7 nm.

7. The composite nanofiltration membrane of claim 2, wherein the chitosan thin layer has a thickness of 60 to 100 nm.

8. The composite nanofiltration membrane of claim 7, wherein the polymer is poly(ether sulfone), the support layer has a thickness of 50 to 500 μm, and the composite nanofiltration membrane has a mean pore size greater than 0.3 nm.

9. The composite nanofiltration membrane of claim 8, wherein the composite nanofiltration membrane has a mean pore size less than 0.7 nm.

10. The composite nanofiltration membrane of claim 7, wherein the composite nanofiltration membrane has a mean pore size greater than 0.3 μm and less than 0.7 nm.

11. The composite nanofiltration membrane of claim 10, wherein the composite nanofiltration membrane has a pure water permeability rate of 1 to 10 Lm⁻²h⁻¹bar⁻¹, a MgCl₂ rejection rate of 85 to 99.9%, a Pb(NO₃)₂ rejection rate of 85 to 99.9%, and a NiCl₂ rejection rate of 85 to 99.9%.

12. The composite nanofiltration membrane of claim 1, wherein the cross-linking agent is selected from the group consisting of trimesoyl chloride, iso-phthaloyl dichloride, sebacoyl chloride, and a combination thereof.

13. The composite nanofiltration membrane of claim 12, wherein the polymer is poly(ether sulfone), the cross-linking agent is trimesoyl chloride, the support layer has a thickness of 50 to 500 μm, the chitosan thin layer has a thickness of 60 to 100 nm, and the composite nanofiltration membrane has a mean pore size greater than 0.3 nm and less than 0.7 nm.

14. The composite nanofiltration membrane of claim 13, wherein the composite nanofiltration membrane has a pure water permeability rate of 1 to 10 Lm⁻²h⁻¹bar⁻¹, a MgCl₂ rejection rate of 85 to 99.9%, a Pb(NO₃)₂ rejection rate of 85 to 99.9%, and a NiCl₂ rejection rate of 85 to 99.9%.

15. A method of preparing a composite nanofiltration membrane, the method comprising:
providing a support layer,
dissolving chitosan in a solvent to form a chitosan solution having a chitosan concentration greater than 0.5 wt % and less than 10 wt %,
coating only a top surface of the support layer with the chitosan solution to obtain a chitosan thin layer,
drying the chitosan thin layer thus obtained to remove the solvent, and
cross-linking the chitosan thin layer thus dried with a cross-linking agent via interfacial polymerization to form a composite nanofiltration membrane.

16. The method of claim 15, wherein the coating step is performed for 2 seconds to 15 minutes, the drying step is performed for 12 to 24 hours, and the cross-linking step is performed for 2 seconds to 10 minutes.

17. The method of claim 16, wherein the coating step is performed for 30 seconds to 5 minutes, the drying step is performed for 12 to 18 hours, and the cross-linking step is performed for 30 seconds to 5 minutes.

18. The method of claim 17, wherein the coating step is performed for 1 to 3 minutes, the drying step is performed for 14 to 18 hours, and the cross-linking step is performed for 30 seconds to 3 minutes.

19. The method of claim 15, wherein the chitosan solution has a chitosan concentration greater than 0.5 wt % and less than 3 wt %.

20. The method of claim 19, wherein the chitosan solution has a chitosan concentration greater than 0.5 wt % and less than 2 wt %.

21. The method of claim 15, wherein the drying step is performed at a temperature of 15 to 65° C.

22. The method of claim 21, wherein the drying step is performed at a temperature of 15 to 50° C.

23. The method of claim 22, wherein the drying step is performed at a temperature of 20 to 35° C.

24. A composite nanofiltration membrane prepared by the method of claim 14, the nanofiltration membrane comprising:
a support layer having a thickness of 100 nm to 10 mm, and
a cross-linked chitosan thin layer having a thickness of 10 to 1000 nm and disposed only on a top surface of the support layer,
wherein
the support layer is formed of a polymer;
the cross-linked chitosan thin layer contains links each formed from a cross-linking agent; and
the composite nanofiltration membrane has a mean pore size less than 1 nm.

25. The composite nanofiltration membrane of claim 24, wherein the polymer is poly(ether sulfone), the cross-linking agent is selected from the group consisting of trimesoyl chloride, iso-phthaloyl dichloride, sebacoyl chloride, and a combination thereof, the support layer has a thickness of 50 to 500 μm, the chitosan thin layer has a thickness of 60 to 100 nm, and the composite nanofiltration membrane has a mean pore size greater than 0.3 nm and less than 0.7 nm.

26. The composite nanofiltration membrane of claim 25, wherein the composite nanofiltration membrane has a pure water permeability rate of 1 to 10 Lm⁻²h⁻¹bar⁻¹, a MgCl₂ rejection rate of 85 to 99.9%, a Pb(NO₃)₂ rejection rate of 85 to 99.9%, and a NiCl₂ rejection rate of 85 to 99.9%.
